(19) United States
(12) Patent Application Publication
(10) Pub. No.: US 2024/0243405 A1
(43) Pub. Date: Jul. 18, 2024

(54) ENERGY STORAGE APPARATUS

(71) Applicant: GS Yuasa International Ltd., Kyoto (JP)

(72) Inventor: Satoru KAWAKAMI, Kyoto (JP)

(73) Assignee: GS Yuasa International Ltd., Kyoto (JP)

(21) Appl. No.: 18/619,247

(22) Filed: Mar. 28, 2024

Related U.S. Application Data
(63) Continuation of application No. PCT/JP2022/032703, filed on Aug. 31, 2022.

(30) Foreign Application Priority Data
Sep. 28, 2021 (JP) 2021-157906

(51) Int. Cl. H01M 50/242; H01M 50/133; H01M 50/15; H01M 50/169; H01M 50/209

(52) U.S. Cl. CPC H01M 50/242; H01M 50/133; H01M 50/15; H01M 50/169; H01M 50/209

(57) ABSTRACT

An energy storage apparatus includes a pair of end members positioned in first direction and opposed to each other, and energy storage devices arrayed in the first direction between the pair of end members. Each of the energy storage devices includes an electrode assembly and a case accommodating the electrode assembly. The case has a pair of side wall portions opposed to each other. The energy storage devices include an energy storage device positioned adjacent to one of the end members such that a wall thickness of one side wall portion adjacent to the one of the end members is larger than a wall thickness of the other side wall portion in the energy storage device.

### CROSS-REFERENCE TO RELATED APPLICATIONS

The present application is a continuation of and claims the benefit of priority to International Application No. PCT/JP2022/032703, filed Aug. 31, 2022, which is based upon and claims the benefit of priority to Japanese Application No. 2021-157906, filed Sep. 28, 2021. The entire contents of these applications are incorporated herein by reference.

### BACKGROUND OF THE INVENTION

### Field of the Invention

The present invention relates to an energy storage apparatus including an energy storage device.

### Description of Background Art

JP-A-2018-137191 describes a battery pack (energy storage apparatus) including a pair of end plates (opposing members) positioned in a predetermined direction and opposed to each other, and secondary batteries (energy storage devices) arrayed in a predetermined direction between the pair of end plates. The entire contents of this publication are incorporated herein by reference.

### SUMMARY OF THE INVENTION

According to one aspect of the present invention, an energy storage apparatus includes a first end member, a second end member opposed to the first end member such that the first and second end members are positioned in a first direction, and a plurality of energy storage devices arrayed side by side in the first direction such that the plurality of energy storage devices is positioned between the first end member and the second end member. Each of the energy storage devices includes an electrode assembly, and a case accommodating the electrode assembly, the plurality of energy storage devices includes a first energy storage device positioned adjacent to the first end member and a second energy storage device positioned adjacent to the second end member, and the first energy storage device is formed such that the case of the first energy storage device has one side wall portion positioned adjacent to the first end member and an opposite side wall portion positioned on an opposite side with respect to the one side wall portion and that a wall thickness of the one wall portion is formed larger than a wall thickness of the opposite side wall portion.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view showing an external appearance of an energy storage apparatus according to an embodiment of the present invention;

FIG. 2 is an exploded perspective view showing respective components when an energy storage apparatus according to an embodiment of the present invention is disassembled;

FIG. 3 is a perspective view showing a configuration of an energy storage apparatus according to an embodiment of the present invention;

FIG. 4 is an exploded perspective view showing respective components of an energy storage apparatus according to an embodiment of the present invention in an exploded manner;

FIG. 5 is an explanatory view showing a welding depth when a pair of first side wall portions is welded to a lid body according to an embodiment of the present invention;

FIG. 6 is a cross-sectional view showing a positional relationship between a pair of end members and a case body of each energy storage device according to an embodiment of the present invention; and

FIG. 7 is a cross-sectional view showing a positional relationship between the pair of end members and a case body of each energy storage device according to a modification example.

### DETAILED DESCRIPTION OF THE EMBODIMENTS

Embodiments will now be described with reference to the accompanying drawings, wherein like reference numerals designate corresponding or identical elements throughout the various drawings.

In the following description and drawings, an arraying direction of energy storage devices, an opposing direction of long side surfaces of a case of the energy storage device, an arraying direction of the energy storage devices and spacers, or a positioning direction of a pair of end members is defined as an X-axis direction. A positioning direction of a pair of (positive electrode and negative electrode) electrode terminals in one energy storage device, an opposing direction of short side surfaces of the case of the energy storage device, or a positioning direction of a pair of side members is defined as a Y-axis direction. A positioning direction of the outer case body and the outer case lid body of the energy storage apparatus, a positioning direction of the case body and a lid body 230 of the energy storage device, an arraying direction of the energy storage device and a bus bar, or a vertical direction is defined as a Z-axis direction. The X-axis direction is an example of a first direction, and the Z-axis direction is an example of a second direction. The X-axis direction, the Y-axis direction, and the Z-axis direction are directions intersecting (orthogonal in the present embodiment) with each other. Although the Z-axis direction may not be the vertical direction depending on the usage mode, the Z-axis direction will be described below as the vertical direction for convenience of description.

In the following description, the X-axis plus direction indicates an arrow direction of the X axis, and the X-axis minus direction indicates a direction opposite to the X-axis plus direction. Simply referring to the X-axis direction refers to either or both of the X-axis plus direction and the X-axis minus direction. The same applies to the Y-axis direction and the Z-axis direction. Expressions indicating relative directions or postures, such as parallel and orthogonal include cases of being not strictly the directions or postures. Two directions being parallel to each other not only means that the two directions are completely parallel to each other, but also means that the two directions are substantially parallel to each other, that is, a difference of about several percent is allowed. Furthermore, in the following description, the expression “insulation” means “electrical insulation”.

### Embodiment

### Energy Storage Apparatus

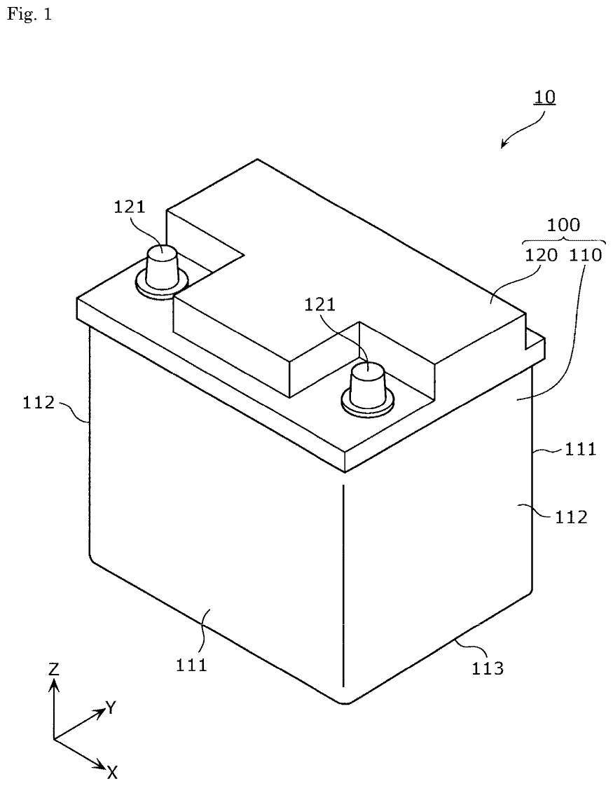

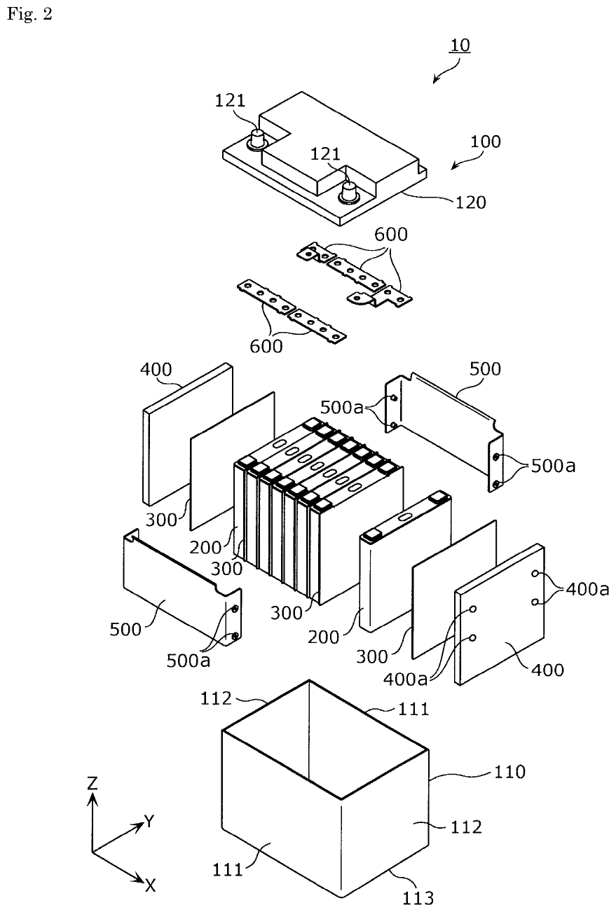

FIG. 1 is a perspective view showing an external appearance of the energy storage apparatus 10 according to an embodiment of the present invention. FIG. 2 is an exploded perspective view showing respective components when the energy storage apparatus 10 according to the present embodiment is disassembled.

As shown in FIG. 1, the energy storage apparatus 10 includes an outer case 100. As shown in FIG. 2, energy storage devices 200, spacers 300, a pair of end members 400, a pair of side members 500, bus bars 600, and the like are accommodated in the outer case 100. In addition to the above-mentioned components, the energy storage apparatus 10 may include a bus bar holder which holds the bus bars 600, a circuit board which monitors a charged state and a discharged state of the energy storage devices 200, electric devices such as a fuse, a relay, and a connector, and an exhaust portion which exhausts a gas discharged from the energy storage devices 200 outward from the outer case 100.

The outer case 100 is a case (module case) having a box shape (substantially rectangular parallelepiped shape) which forms a casing (outer shell) of the energy storage apparatus 10. The outer case 100 is disposed outward from the energy storage devices 200 and the like, fixes the energy storage devices 200 and the like at predetermined positions, and protects the energy storage devices 200 and the like from an impact or the like. The outer case 100 is formed of an insulating member such as polycarbonate (PC), polypropylene (PP), polyethylene (PE), polystyrene (PS), a polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), polyamide (PA), an ABS resin, or a composite material thereof, or an insulation-coated metal. With such a configuration, the outer case 100 prevents the energy storage devices 200 and the like from coming into contact with an external metal member or the like. The outer case 100 may be formed of a conductive member such as metal as long as insulation of the energy storage devices 200 and the like is maintained.

The outer case 100 includes an outer case body 110 which forms a body of the outer case 100 and an outer case lid body 120 which forms a lid body of the outer case 100. The outer case body 110 is a bottomed rectangular cylindrical housing (casing) in which an opening directed in the Z-axis plus direction is formed, and accommodates the energy storage devices 200 and the like therein. The outer case lid body 120 is a flat rectangular member which closes the opening of the outer case body 110. The outer case lid body 120 is provided with a pair of (positive electrode and negative electrode) external terminals 121. The energy storage apparatus 10 charges electricity from the outside and discharges electricity to the outside through the pair of external terminals 121.

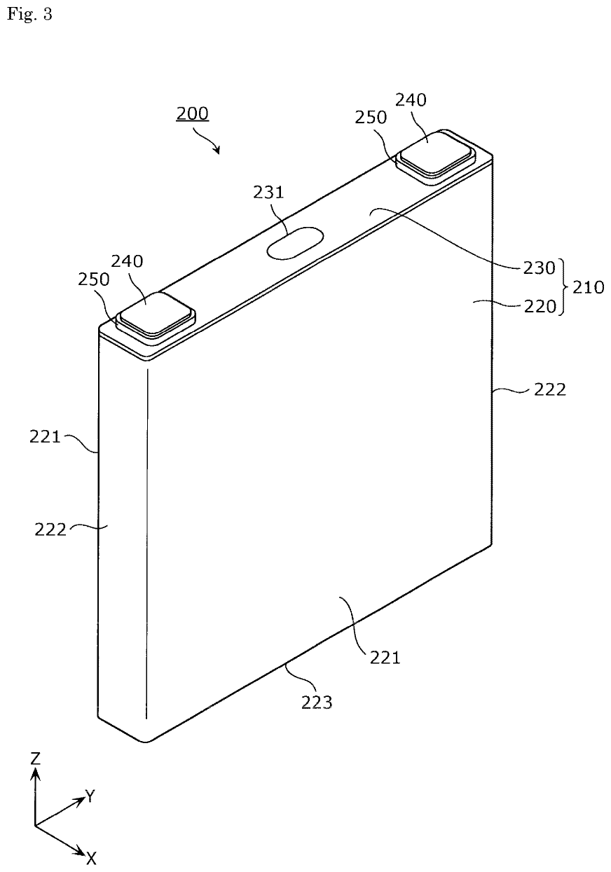

The outer case body 110 includes a pair of wall portions 111 opposed to each other on both side surfaces in the Y axis direction, a pair of wall portions 112 opposed to each other on both side surfaces in the X axis direction, and wall portions 113 opposed to each other on a Z-axis minus direction side. The wall portion 113 is a rectangular and flat plate-like wall portion (bottom wall portion) which forms a bottom surface of the outer case 100, and is disposed to be opposed to bottom wall portions 223 (see FIG. 3) of cases 210 of the energy storage devices 200 in the Z axis direction. The wall portion 113 is adjacent to the wall portions 111 and 112. The outer case body 110 and the outer case lid body 120 are joined to each other by heat sealing (heat welding), ultrasonic welding, laser welding, an adhesive or the like.

The energy storage device 200 is a secondary battery (battery cell) capable of charging and discharging electricity, and more specifically, is a nonaqueous electrolyte secondary battery such as a lithium ion secondary battery. The energy storage device 200 has a flat rectangular parallelepiped shape (prismatic shape), and in the present embodiment, eight energy storage devices 200 are arrayed side by side in the X-axis direction. The size and shape of the energy storage devices 200, the number of the arrayed energy storage devices 200, and the like are not limited, and only one energy storage device 200 may be positioned. The energy storage device 200 is not limited to the nonaqueous electrolyte secondary battery, and may be a secondary battery other than the nonaqueous electrolyte secondary battery, or may be a capacitor. The energy storage device 200 may be not a secondary battery but a primary battery that can use stored electricity unless being charged by a user. The energy storage device 200 may be a pouch type energy storage device. The configuration of the energy storage device 200 will be described in detail later.

The spacer 300 is a flat-plate-like rectangular-shaped member which is disposed side by side with the energy storage device 200 (in the X-axis plus direction or the X-axis minus direction) on a side of the energy storage device 200 and provides insulation between the energy storage device 200 and other members. The spacer 300 is disposed between two energy storage devices 200 adjacent to each other and between the energy storage device 200 at the end portion and the end member 400, and provides insulation between the two energy storage devices 200 and between the energy storage device 200 at the end portion and the end member 400. In the present embodiment, nine spacers 300 are arrayed corresponding to the eight energy storage devices 200, but the arraying position, the number, and the like of the spacers 300 are not particularly limited. The spacer 300 is formed of a member having an insulating property such as any resin material which can be used for the outer case 100, a member having a heat insulating property such as a dammar material formed by accumulating and bonding mica pieces, or the like.

The end member 400 and the side member 500 are binding members which press (restrain) the energy storage devices 200 from the outside in the arraying direction (X axis direction) of the energy storage devices 200. The end member 400 and the side member 500 press (restrain) the respective energy storage devices 200 included in the energy storage devices 200 from both sides in the arraying direction by sandwiching the energy storage devices 200 from both sides in the arraying direction. The end member 400 and the side member 500 are formed of a metal member such as steel or stainless steel from the viewpoint of securing strength and the like, but the material thereof is not particularly limited, and may be formed of an insulating member having high strength, or may be formed of a metal member subjected to an insulation treatment.

The end member 400 is a plate-like and rectangular binding member (end plate) which is disposed on both sides in the X axis direction of the energy storage devices 200 and the spacers 300 and sandwiches and holds the energy storage devices 200 and the like from both sides in the arraying direction (X axis direction) of the energy storage devices 200 and the like. The pair of end members 400 is an example of opposing members which are disposed so as to be opposed to each other in the X axis direction (first direction). The energy storage devices 200 and the spacers 300 arrayed in the X axis direction are disposed between the pair of end members 400. Accordingly, the pair of end members 400 restrains the energy storage devices 200 and the spacers 300 in the X axis direction. The end member 400 may be a flat block-shaped member or the like instead of a plate-like member.

The side members 500 are plate-like and elongated binding members (side plates) which are disposed on both sides of the energy storage devices 200 and the spacers 300 in the Y axis direction so as to be opposed to the energy storage devices 200 and the like in the Y axis direction. Both ends of the pair of side members 500 are attached to the pair of end members 400 and connect the pair of end members 400, thereby binding the energy storage devices 200 and the spacers 300. That is, the side member 500 is disposed so as to extend in the X axis direction so as to straddle the energy storage devices 200 and the spacers 300 and applies a binding force to the energy storage devices 200 and the like in the arraying direction thereof (X axis direction). The side member 500 may be a long rod-shaped member or the like instead of a plate-like member.

The pair of side members 500 is attached to the ends in the Y axis direction of the pair of end members 400 at both end portions in the X axis direction. Accordingly, the pair of side members 500 sandwiches and restrains the energy storage devices 200 and the like from both sides in the X axis direction and both sides in the Y axis direction together with the pair of end members 400. Specifically, the side member 500 is connected (joined) to a connecting portion 400a of the end member 400 by two connecting portions 500a formed in the Z axis direction. In the present embodiment, the connecting portion 500a is a bolt (screw), and is fastened by screwing with a female screw portion formed in the connecting portion 400a of the end member 400. The connection (joining) of the side member 500 to the end member 400 is not limited to the fixing by the bolt (screw), and may be joined by welding, adhesion, or the like. The configuration of the side member 500 will be described in detail later.

The bus bars 600 are plate-like members connected to the energy storage devices 200. The bus bars 600 are disposed above the energy storage devices 200 and are connected (joined) to electrode terminals 240 (see FIG. 3) of the energy storage devices 200. To be more specific, the bus bars 600 connect the electrode terminals 240 of the energy storage devices 200 to each other, and electrically connect the electrode terminals 240 of the energy storage devices 200 at end portions to the external terminals 121. In the present embodiment, the bus bars 600 form four sets of energy storage device groups by connecting two energy storage devices 200 in parallel, and connect the four sets of energy storage device groups in series. The connection form of the bus bars 600 is not particularly limited, and the energy storage devices 200 may be connected in series or in parallel in any combination, or all the energy storage devices 200 may be connected in series or in parallel. The bus bar 600 and the electrode terminal 240 are connected (joined) by welding, but a connection form thereof is not particularly limited. The bus bar 600 is formed of a conductive member made of metal such as aluminum, an aluminum alloy, copper, a copper alloy, or nickel, a combination thereof, a conductive member other than metal, or the like.

The energy storage apparatus 10 is an apparatus capable of charging electricity from the outside and discharging electricity to the outside and has a substantially rectangular parallelepiped shape in the present embodiment. The energy storage apparatus 10 is a battery module (assembled battery) used for power storage application, power supply application, or the like. Specifically, the energy storage apparatus 10 is used as a battery or the like for driving or starting an engine of a moving body such as an automobile, a motorcycle, a watercraft, a ship, a snowmobile, an agricultural machine, a construction machine, or a railway vehicle for an electric railway. Examples of the automobile include an electric vehicle (EV), a hybrid electric vehicle (HEV), a plug-in hybrid electric vehicle (PHEV), and a fossil fuel (gasoline, light oil, liquefied natural gas, etc.) automobile. Examples of the railway vehicle for an electric railway include a train, a monorail, a linear motor car, and a hybrid train including both a diesel engine and an electric motor. The energy storage apparatus 10 can also be used as a stationary battery or the like used for home use, business use, or the like.

### Energy Storage Device

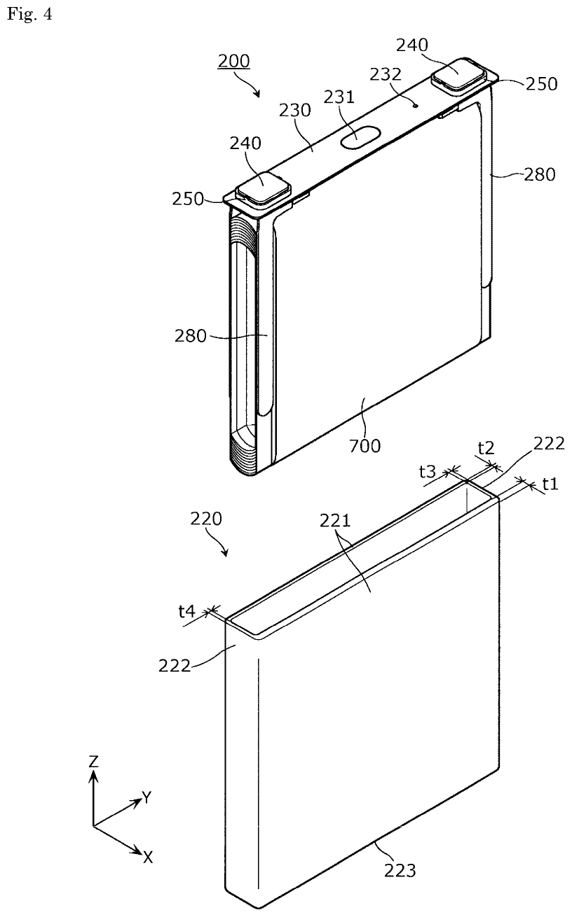

Next, the configuration of the energy storage device 200 will be described in detail. FIG. 3 is a perspective view showing the configuration of the energy storage device 200 according to the present embodiment. To be more specific, FIG. 3 shows an enlarged external appearance of one energy storage device 200 out of the energy storage devices 200 shown in FIG. 2. FIG. 4 is an exploded perspective view showing respective components of the energy storage device 200 according to the present embodiment in an exploded manner. Since all of the energy storage devices 200 have the same configuration, the configuration of one energy storage device 200 will be described in detail below.

As shown in FIG. 3, the energy storage device 200 includes a case 210, a pair of (positive electrode and negative electrode) electrode terminals 240, and an upper gasket 250. As shown in FIG. 4, lower gaskets (not shown) for the positive electrode and the negative electrode, an electrode assembly 700, and current collectors 280 for the positive electrode and the negative electrode are accommodated in the case 210. Although an electrolyte solution (nonaqueous electrolyte) is accommodated in the case 210, the illustration thereof is omitted. A type of the electrolyte solution is not particularly limited as long as performance of the energy storage device 200 is not impaired, and various types of electrolyte solutions can be selected.

In addition to the above-mentioned components, the energy storage device 200 may include a spacer disposed on a side, a lower side, or the like of the electrode assembly, an insulating film enclosing the electrode assembly or the like, and the like. Furthermore, an insulating film (shrink tube or the like) that covers the outer surface of the case 210 may be disposed around the case 210. The material of the insulating film is not particularly limited as long as the insulating property necessary for the energy storage device 200 can be secured, and any insulating resin, epoxy resin, Kapton (registered trademark), Teflon (registered trademark), silicon, polyisoprene, polyvinyl chloride, and the like which can be used for the outer case 100 can be exemplified.

The case 210 is a rectangular parallelepiped (prismatic) case having a case body 220 in which one end portion in the Z-axis plus direction (second direction) is opened and a lid body 230 that closes one end portion of the case body 220. The material of the case 210 (the case body 220 and the lid body 230) is not particularly limited, and may be weldable (joinable) metal such as stainless steel, aluminum, an aluminum alloy, iron, or a plated steel plate, but resin can also be used.

The case body 220 is a member having a rectangular cylindrical shape constituting a body portion of the case 210 and having a bottom and is formed of a single member. The case body 220 having a rectangular cylindrical shape and a bottom is formed by drawing a flat plate made of the above-described material. Note that any manufacturing method may be used as long as the case body 220 including one member can be formed. Other manufacturing methods include cutting, casting, sintering, 3D printing methods, and the like.

The case body 220 has a pair of first side wall portions 221 on both sides in the X-axis direction, a pair of second side wall portions 222 on both sides in the Y-axis direction, and a bottom wall portion 223 on the Z-axis minus direction side. To be more specific, the first side wall portion 221 is a rectangular plate-like long side surface portion which forms a long side surface of the case 210. In other words, the first side wall portion 221 is a wall portion which is adjacent to the second side wall portions 222 and the bottom wall portion 223 and has a larger surface area (outer surface area) than the second side wall portions 222. The pair of first side wall portions 221 is opposed to each other with the electrode assembly 700 interposed therebetween in the X axis direction. Out of the pair of first side wall portions 221, a wall thickness t1 (width in the X axis direction) of one first side wall portion 221 in the X-axis plus direction is formed to be larger than a wall thickness t2 of the other first side wall portion 221 in the X-axis minus direction. Here, the wall thickness t2 is preferably 0.3 mm or more and 1.0 mm or less from the viewpoint of securing the welding margin. The difference t1−t2 between the wall thickness t1 and the wall thickness t2 is preferably 0.1 mm or more, and preferably 0.7 mm or less. The wall thickness t1 is preferably 1.1 times or more the wall thickness t2. The wall thickness t1 and the wall thickness t2 are determined from an average value of thicknesses of arbitrary three portions obtained from imaging data obtained by imaging the energy storage apparatus 10 with a X-ray CT.

The second side wall portion 222 is a rectangular plate-like short side surface portion forming a short side surface of the case 210. In other words, the second side wall portion 222 is a wall portion which is adjacent to the first side wall portions 221 and the bottom wall portion 223 and has a smaller surface area (outer surface area) than the first side wall portions 221. The pair of second side wall portions 222 is opposed to each other with the electrode assembly 700 interposed therebetween in the Y axis direction.

In the present embodiment, a case where wall thicknesses t3 and t4 (widths in the Y axis direction) of the pair of second side wall portions 222 are equal to the wall thickness t2 is illustrated, but may be equal to the wall thickness t1 or may be different from the wall thicknesses t1 and t2. Furthermore, the wall thicknesses t3 and t4 of the pair of second side wall portions 222 may be different from each other.

The bottom wall portion 223 is a rectangular plate-like bottom wall portion forming a bottom surface of the case 210. The lid body 230 may have any wall thickness (width in the Z-axis direction).

The lid body 230 is a rectangular plate-shaped member constituting a lid portion of the case 210 and is disposed on the Z-axis plus direction side of the case body 220. That is, the lid body 230 is a wall portion which is opposed to the bottom wall portion 223 in the Z axis direction and is adjacent to the first side wall portions 221 and the second side wall portions 222. In the present embodiment, the electrode terminals 240 of the positive electrode and the negative electrode are disposed on the lid body 230, and further, a gas release valve 231 that releases the pressure when the pressure inside the case 210 increases, an electrolyte solution filling portion 232 for filling an electrolyte solution into the case 210, and the like are also provided.

With such a configuration, the case 210 has a structure in which the inside is sealed by joining the case body 220 and the lid body 230 by welding or the like after the electrode assembly 700 is accommodated in the case body 220.

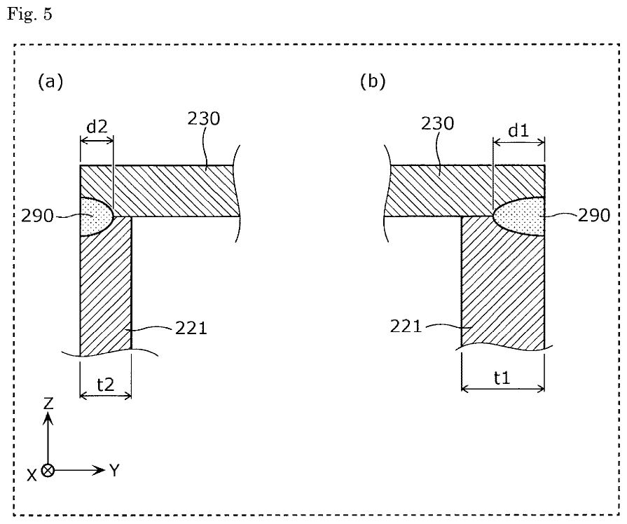

FIG. 5 is an explanatory view showing a welding depth when the pair of first side wall portions 221 is welded to the lid body 230 according to the present embodiment. FIG. 5(a) is a cross-sectional view showing a welding depth between the lid body 230 and the other first side wall portion 221, and FIG. 5(b) is a cross-sectional view showing a welding depth between the lid body 230 and the one first side wall portion 221.

As shown in FIG. 5, the boundary between the case body 220 and the lid body 230 is continuously welded over the entire circumference from the outside of the case body 220 in a state where the lid body 230 is overlapped on the end surface of the case body 220 in the Z-axis plus direction. As a result, the boundary is melted and joined to form a welded portion 290. A welding depth (a depth in the X-axis direction or the Y-axis direction) of the welded portion 290 is adjusted according to the wall thickness (thickness t1, t2, t3, t4) of each side wall portion. Assuming that d1 is a welding depth of the welded portion 290 in the side wall portion (one first side wall portion 221 having a large wall thickness (see FIG. 5(b))), and that d2 is a welding depth of the welded portion 290 in the thin side wall portion (other first side wall portion 221 (see FIG. 5(a)), the pair of second side wall portions 222), d1>d2 is satisfied.

The electrode terminals 240 are terminal members (a positive electrode terminal and a negative electrode terminal) of the energy storage device 200 disposed on the lid body 230 and is electrically connected to the positive electrode plate and the negative electrode plate of the electrode assembly through the current collector 280. The electrode terminal 240 is a metal member for leading out electricity stored in the electrode assembly to a space outside the energy storage device 200 and for introducing electricity into a space inside the energy storage device 200 so as to store electricity in the electrode assembly. The electrode terminal 240 is made of aluminum, an aluminum alloy, copper, a copper alloy, or the like.

The electrode assembly 700 is an energy storage element (power generating element) formed by stacking the positive electrode plate, the negative electrode plate, and a separator. The positive electrode plate is obtained by forming a positive active material layer on a positive electrode substrate layer which is a current collecting foil made of metal such as aluminum or an aluminum alloy. The negative electrode plate is obtained by forming a negative active material layer on a negative electrode substrate layer which is a current collecting foil made of metal such as copper or a copper alloy. As the active material used for the positive active material layer and the negative active material layer, a known material may be appropriately used as long as it can occlude and release lithium ions. As the separator, a microporous sheet or nonwoven fabric made of a resin can be used. In the present embodiment, the electrode assembly is formed by laminating plates (a positive electrode plate and a negative electrode plate) in the X axis direction. The electrode assembly may be an electrode assembly in any form such as a winding-type electrode assembly formed by winding plates (a positive electrode plate and a negative electrode plate), a stacking-type electrode assembly formed by stacking plate-shaped plates, or a bellows-type electrode assembly formed by folding plates in a bellows shape.

The current collector 280 is a conductive member (a positive electrode current collector and a negative electrode current collector) electrically connected to the electrode terminal 240 and the electrode assembly 700. The positive electrode current collector is formed of aluminum, an aluminum alloy, or the like similarly to the positive electrode substrate layer of the positive electrode plate, and the negative electrode current collector is formed of copper, a copper alloy, or the like similarly to the negative electrode substrate layer of the negative electrode plate. The upper gasket 250 is disposed between the lid body 230 and the electrode terminal 240, and is a gasket that insulates and seals between the lid body 230 and the electrode terminal 240. The lower gasket is disposed between the lid body 230 and the current collector, and insulates and seals between the lid body 230 and the current collector. The upper gasket 250 and the lower gasket may be formed of any material as long as they have insulating properties.

In the energy storage device 200, it is preferable that a mark indicating that the wall thickness of the one first side wall portion 221 is larger than that of the other first side wall portion 221 is formed on a portion visually recognizable from the outside. This mark may be a mark capable of visual discrimination or a mark (engraved mark) capable of tactile discrimination. The portion visually recognizable from the outside includes an outer surface of the case body 220, an outer surface of the lid body 230, a portion exposed to the outside from the lid body 230 and the electrode terminal 240 in the upper gasket 250, a portion exposed to the outside from the upper gasket 250 in the electrode terminal 240, and the like. If the mark is formed only on the outer surface of the one first side wall portion 221, the worker can specify the one first side wall portion 221 having a large wall thickness by looking at or touching the mark.

Positional Relationship between End Members and Case Body of Energy Storage Device

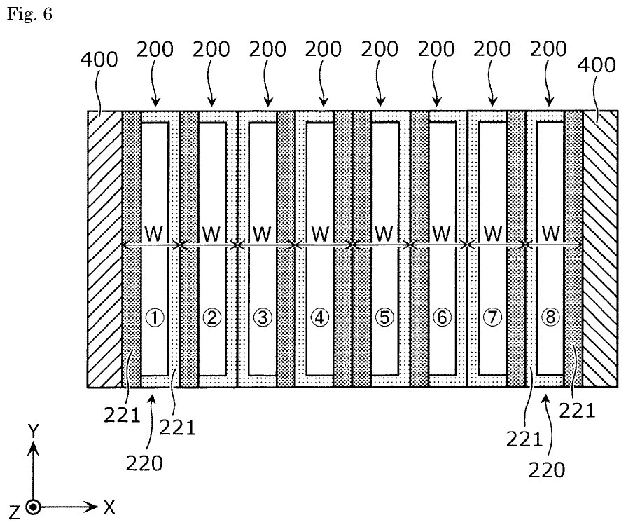

A positional relationship between the pair of end members 400 and the case body 220 of each energy storage device 200 will be described. FIG. 6 is a cross-sectional view showing the positional relationship between the pair of end members 400 and the case body 220 of each energy storage device 200 according to the present embodiment. In FIG. 6, in the case body 220 of each energy storage device 200, a side wall portion (one first side wall portion 221) having a large wall thickness is indicated by thick dot hatching, and side wall portions (the other first side wall portion 221 and the pair of second side wall portions 222) having a small wall thickness are indicated by thin dot hatching. In FIG. 6, the electrode assemblies 700, the spacers 300, and the side members 500 are omitted.

As shown in FIG. 6, the energy storage devices 200 arrayed in the X axis direction are disposed between the pair of end members 400 in a state where the first side wall portions 221 of the adjacent energy storage devices 200 are opposed each other. Since all the energy storage devices 200 have the same configuration as described above, widths W of the energy storage devices 200 in the X axis direction are equal to each other.

In this embodiment, out of the eight energy storage devices 200, the first, second, fifth, and sixth energy storage devices 200 are disposed in such a posture that the one first side wall portion 221 faces the X-axis minus direction from the end portion in the X-axis minus direction. On the other hand, the third, fourth, seventh, and eighth energy storage devices 200 are disposed in such a posture that the one first side wall portion 221 faces the X-axis plus direction from the end portion in the X-axis minus direction. As described above, out of the energy storage devices 200, in the energy storage devices 200 (the first and eighth energy storage devices 200) disposed at both end portions in the X axis direction, one of the first side wall portions 221 having a large wall thickness is adjacent to the end member 400. The other energy storage devices 200 different from the energy storage devices 200 disposed at both end portions may be positioned in any direction as long as each energy storage device 200 is disposed in the direction corresponding to the electrical connection form of each energy storage device.

As has been described heretofore, in the energy storage apparatus 10 according to the embodiment of the present invention, in the energy storage devices 200 disposed at both end portions in the X axis direction (first direction), out of the pair of first side wall portions 221 (side wall portions) of the case 210, the wall thickness t1 of the one first side wall portion 221 adjacent to the end member 400 (opposing member) is larger than the wall thickness t2 of the other first side wall portion 221. That is, the rigidity of the one first side wall portion 221 adjacent to the end member 400 and easily deformed is higher than the rigidity of the other first side wall portion 221. Therefore, the reliability of the energy storage device 200 at the end portion in the X axis direction can be enhanced, and as a result, the reliability of the energy storage apparatus 10 itself can also be enhanced.

Since each of the energy storage devices 200 has the same width W in the X axis direction, handling with respect to each energy storage device 200 can be facilitated, and handling of all the energy storage devices 200 at the time of manufacturing can be facilitated. The lid body 230 can also be made common between the respective energy storage devices 200.

Also in the other energy storage devices 200 different from the energy storage devices 200 at both end portions, since the wall thickness t1 of the one first side wall portion 221 is larger than the wall thickness t2 of the other first side wall portion 221, the energy storage devices 200 at both end portions and the cases 210 of the other energy storage devices 200 can be made common. Therefore, the energy storage apparatus 10 can be easily manufactured.

Since the wall thickness t1 of the one first side wall portion 221 is larger than the wall thickness t2 of the other first side wall portion 221, the welding depth d1 with respect to the one first side wall portion 221 can be made larger than the welding depth d2 with respect to the other first side wall portion 221. Therefore, the joint strength between the one first side wall portion 221 and the lid body 230 can be made larger than the joint strength between the other first side wall portion 221 and the lid body 230. With such a configuration, deformation of the one first side wall portion 221 can be suppressed more reliably and hence, reliability of the energy storage apparatus 10 can be further enhanced.

Since the case body 220 is a single member, the case 210 in which the wall thickness t1 of the one first side wall portion 221 is larger than the wall thickness t2 of the other first side wall portion 221 can be manufactured without performing post-processing such as welding. Therefore, the energy storage apparatus 10 can be easily manufactured.

### Modification Examples

Although the energy storage apparatus 10 according to the present embodiment has been described above, the present invention is not limited to the above-mentioned embodiment. The embodiment disclosed herein is illustrative in all respects and is not restrictive, and the scope of the present invention includes all modifications within the meaning and scope equivalent to the claims.

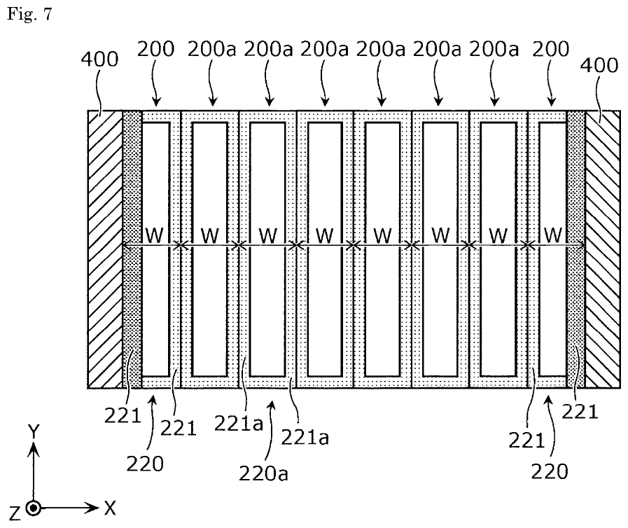

In the above-mentioned embodiment, by way of example, all of the energy storage devices 200 have the same configuration. However, the energy storage devices at both end portions in the X axis direction and other energy storage devices may have different configurations. FIG. 7 is a cross-sectional view showing a positional relationship between the pair of end members 400 and case bodies 220 and 220a of respective energy storage devices 200 and 200a according to the modification example. Specifically, FIG. 7 is a view corresponding to FIG. 6.

Here, the energy storage devices 200 at both end portions in the X axis direction are similar to the energy storage devices 200 exemplified in the embodiment, but the other energy storage devices 200a are different from the energy storage devices 200 in the configuration of the case body 220a. Specifically, in the case body 220a, the pair of first side wall portions 221a has the same wall thickness. In this modification example, a wall thickness of each of the pair of first side wall portions 221a is set to be the same as a wall thickness t2 of the other first side wall portion 221 of the energy storage device 200. The wall thickness of each of the pair of first side wall portions 221a is not necessarily the same as the wall thickness t2 of the other first side wall portion 221 of the energy storage device 200. In this modification example, the respective energy storage devices 200 and 200a have the same width W in the X axis direction. Here, having the same width W in the X axis direction means that the width W of the energy storage device 200 in the X axis direction is in a range of ±5% of the width W in the X axis direction of the energy storage device 200a. The width W in the X axis direction is determined from an average value of thicknesses of arbitrary three portions obtained from imaging data obtained by imaging the energy storage apparatus 10 with a X-ray CT. In the energy storage devices 200 and the energy storage devices 200a, marks which can visually or tactilely distinguish the energy storage devices may be formed.

Also in this modification example, in the energy storage devices 200 disposed at both end portions in the X axis direction, out of the pair of first side wall portions 221 of the case 210, the wall thickness t1 of the one first side wall portion 221 adjacent to the end member 400 is larger than the wall thickness t2 of the other first side wall portion 221. Accordingly, the reliability of the energy storage devices 200 at the end portions in the X axis direction can be enhanced.

### Other Modification Examples

In the above-mentioned embodiment, the pair of end members 400 has been exemplified as a pair of opposing members according to an embodiment of the present invention. However, the pair of opposing members may be formed of any members as long as they are opposed each other in the X axis direction and the energy storage devices 200 arrayed in the X axis direction are disposed between the opposing members. The pair of wall portions 112 of the outer case body 110 may be formed as a pair of opposing members. Thus, the pair of end members 400 and the pair of side members 500 can be removed. In this case, the binding force to the energy storage devices 200 may be applied by the outer case body 110.

In the above-mentioned embodiment, by way of example, the spacer 300 is disposed between the energy storage device 200 at the end portion in the X axis direction and the end member 400. However, the energy storage device 200 at the end portion and the end member 400 may be brought into direct contact with each other.

In the above-mentioned embodiment, by way of example, in each of the energy storage devices 200 at both end portions in the X axis direction, out of the pair of first side wall portions 221 of the case 210, the wall thickness t1 of the one first side wall portion 221 adjacent to the end member 400 is larger than the wall thickness t2 of the other first side wall portion 221. However, only one of the energy storage devices 200 at both end portions in the X axis direction may satisfy this relation.

In the above-mentioned embodiment, the energy storage apparatus 10 in which the other energy storage devices 200 are arrayed between the pair of energy storage devices 200 adjacent to the pair of end members 400 has been exemplified, but the energy storage apparatus 10 may be formed of only the pair of energy storage devices 200.

In the above-mentioned embodiment, by way of example, the energy storage apparatus 10 in which the energy storage devices 200 are arrayed in a row between the pair of end members 400 is formed. However, the energy storage apparatus 10 may be configured such that rows of the energy storage devices 200 are arrayed between the pair of end members 400. In this case, in the energy storage devices 200 at the end portions of each row, the wall thickness of the one first side wall portion 221 adjacent to the end member 400 only needs to be larger than the wall thickness of the other first side wall portion 221.

In the above-mentioned embodiment, by way of example, the widths W of all the energy storage devices 200 are equal to each other. However, the width of at least one energy storage device 200 out of the energy storage devices 200 may be different.

In the above-mentioned embodiment, by way of example, the welding depth d1 with respect to the one first side wall portion 221 is larger than the welding depth d2 with respect to the other first side wall portion 221, but the welding depth d1 may be equal to or smaller than the welding depth d2.

In the above-mentioned embodiment, by way of example, the case body 220 is made of a single material. However, the case body may be formed by assembling members. In this case, the case body may be formed by welding sheet metals. The sheet metals may include at least one of a bent sheet metal and a flat sheet metal.

A form constructed by freely combining the components included in the above-mentioned embodiment and the modification examples thereof is also included in the scope of the present invention.

An embodiment of the present invention can be applied to an energy storage apparatus or the like including an energy storage device such as a lithium ion secondary battery.

An energy storage apparatus according to one aspect of the present invention includes: a pair of opposing members positioned in a first direction and opposed to each other; and energy storage devices arrayed in the first direction between the pair of opposing members, in which each of the energy storage devices includes: an electrode assembly; and a case that accommodates the electrode assembly, in which the case has a pair of side wall portions opposed to each other with the electrode assembly interposed therebetween in the first direction, in which, in the energy storage devices, in an energy storage device disposed at an end portion in the first direction, a wall thickness of one side wall portion of the pair of side wall portions is larger than a wall thickness of the other side wall portion, and in which the one side wall portion is adjacent to the opposing member.

An energy storage apparatus according to one aspect of the present invention, in the energy storage device disposed at the end portion in the first direction, out of the pair of side wall portions of the case, the wall thickness of the one side wall portion adjacent to the opposing member is larger than the wall thickness of the other side wall portion. That is, the rigidity of the one side wall portion adjacent to the opposing member and easily deformed is higher than the rigidity of the other side wall portion. In addition, the expansion of the energy storage device at the end portion in the first direction can be controlled without excessively reducing the capacity of the energy storage device. Therefore, the reliability of the energy storage device at the end portion in the first direction can be enhanced, and as a result, the reliability of the energy storage apparatus itself can also be enhanced.

In the energy storage apparatus, each of the energy storage devices may have the same width in the first direction. Since the energy storage devices have the same width in the first direction, handling of all the energy storage devices at the time of manufacturing can be facilitated.

In the energy storage apparatus, in the energy storage devices, in another energy storage device different from the energy storage device disposed at the end portion, a wall thickness of one side wall portion of the pair of side wall portions may be larger than a wall thickness of the other side wall portion. In addition, regarding to the energy storage device different from the energy storage device disposed at the end portion, since the wall thickness of the one side wall portion of the pair of side wall portions may be larger than the wall thickness of the other side wall portion, the expansion of the energy storage device different from the energy storage device disposed at the end portion can be controlled without excessively reducing the capacity of the energy storage device. Therefore, the reliability of the energy storage device different from the energy storage device disposed at the end portion can be further enhanced, and as a result, the reliability of the energy storage apparatus itself can also be further enhanced. Also in the other energy storage devices, since the wall thickness of the one side wall portion is larger than the wall thickness of the other side wall portion, the cases of the energy storage device at the end portion and the other energy storage device can be made common. Therefore, the energy storage apparatus can be easily manufactured.

In the energy storage apparatus, the case may include a case body having the pair of side wall portions and having one end portion opened in a second direction intersecting the first direction, and a lid body that closes one end portion of the case body, a boundary between the lid body and the case body may be welded in a state where the lid body is disposed so as to overlap the one end portion of the case body, and a welding depth with respect to the one side wall portion may be deeper than a welding depth with respect to the other side wall portion. Since the wall thickness of the one side wall portion is larger than that of the other side wall portion, the welding depth with respect to the one side wall portion can be made larger than the welding depth with respect to the other side wall portion. Therefore, the joint strength between the one side wall portion and the lid body can be made larger than the joint strength between the other side wall portion and the lid body. With such a configuration, deformation of the one side wall portion can be suppressed more reliably and hence, reliability of the energy storage apparatus can be further enhanced.

In the energy storage apparatus, the case may include a case body having the pair of side wall portions and having one end portion opened in a second direction intersecting the first direction, and a lid body that closes one end portion of the case body, and the case body may be formed of a single member. Since the case body is formed of one member, the case in which the wall thickness of the one side wall portion is larger than the wall thickness of the other side wall portion can be manufactured without performing post-processing such as welding. Therefore, the energy storage apparatus can be easily manufactured.

JP-A-2018-137191 describes a battery pack (energy storage apparatus) including a pair of end plates (opposing members) positioned in a predetermined direction and opposed to each other, and secondary batteries (energy storage devices) arrayed in a predetermined direction between the pair of end plates.

The energy storage device has a characteristic of gradually expanding as charging and discharging are repeated. In the other energy storage devices other than a pair of energy storage devices disposed at both end portions in the predetermined direction, the adjacent energy storage devices receive a reaction force generated when the energy storage devices expand to each other, and hence the expansion of the energy storage devices is suppressed. On the other hand, in the energy storage device disposed at the end portion, there is no other energy storage device outward from the energy storage device, and the energy storage device does not receive a reaction force from the energy storage device, so that the energy storage device can be deformed more than the other energy storage devices. As a result, the case may be broken in the energy storage device at the end portion. In particular, the case of the energy storage device at the end portion has a pair of side wall portions opposed to each other in a predetermined direction. However, out of the pair of side wall portions, the side wall portion positioned outward is more likely to be deformed and broken than the other side wall portion.

An energy storage apparatus according to an embodiment of the present invention enhances reliability by enhancing reliability of an energy storage device disposed at an end portion.

An energy storage apparatus according to one aspect of the present invention includes a pair of opposing members positioned in a first direction and opposed to each other, and energy storage devices arrayed in the first direction between the pair of opposing members, in which each of the energy storage devices includes an electrode assembly, and a case that accommodates the electrode assembly, in which the case has a pair of side wall portions opposed to each other with the electrode assembly interposed therebetween in the first direction, in which, in the energy storage devices, in an energy storage device disposed at an end portion in the first direction, a wall thickness of one side wall portion of the pair of side wall portions is larger than a wall thickness of the other side wall portion, and in which the one side wall portion is adjacent to the opposing member.

In an energy storage apparatus according to an embodiment of the present invention, the reliability can be enhanced.

Obviously, numerous modifications and variations of the present invention are possible in light of the above teachings. It is therefore to be understood that within the scope of the appended claims, the invention may be practiced otherwise than as specifically described herein.

1. An energy storage apparatus, comprising:
a first end member;
a second end member opposed to the first end member such that the first and second end members are positioned in a first direction; and
a plurality of energy storage devices arrayed side by side in the first direction such that the plurality of energy storage devices is positioned between the first end member and the second end member,
wherein each of the energy storage devices includes an electrode assembly, and a case accommodating the electrode assembly, the plurality of energy storage devices includes a first energy storage device positioned adjacent to the first end member and a second energy storage device positioned adjacent to the second end member, and the first energy storage device is formed such that the case of the first energy storage device has one side wall portion positioned adjacent to the first end member and an opposite side wall portion positioned on an opposite side with respect to the one side wall portion and that a wall thickness of the one wall portion is formed larger than a wall thickness of the opposite side wall portion.

2. The energy storage apparatus according to claim 1, wherein the plurality of energy storage devices is formed such that the energy storage devices have a same width in the first direction.

3. The energy storage apparatus according to claim 1, wherein the plurality of energy storage devices includes at least one energy storage device arrayed between the first and second energy storage devices such that the at least one energy storage device has the case having one side wall portion with a wall thickness that is larger than a wall thickness of an opposite side wall portion and that the case of the first energy storage device and the case of the at least one energy storage device have a common structure.

4. The energy storage apparatus according to claim 1, wherein the first energy storage device is formed such that the case of the first energy storage device includes a lid body closing an opening of the case and that the lid body is welded onto the one side wall portion with a welding depth that is deeper than a welding depth of the opposite side wall portion.

5. The energy storage apparatus according to claim 1, wherein the case includes a case body and a lid body closing an opening end portion of the case body such that the case body is formed of a single member comprising the one and opposite side wall portions.

6. The energy storage apparatus according to claim 2, wherein the plurality of energy storage devices includes at least one energy storage device arrayed between the first and second energy storage devices such that the at least one energy storage device has the case having one side wall portion with a wall thickness that is larger than a wall thickness of an opposite side wall portion and that the case of the first energy storage device and the case of the at least one energy storage device have a common structure.

7. The energy storage apparatus according to claim 1, wherein the plurality of energy storage devices includes at least one energy storage device arrayed between the first and second energy storage devices such that the at least one energy storage device has the case having one side wall portion with a wall thickness that is larger than a wall thickness of an opposite side wall portion.

8. The energy storage apparatus according to claim 1, wherein the plurality of energy storage devices includes at least one energy storage device arrayed between the first and second energy storage devices such that the case of the at least one energy storage device has one side wall portion and an opposite side wall portion with a same wall thickness.

9. The energy storage apparatus according to claim 1, further comprising:
a plurality of spacers positioned between the plurality of energy storage devices respectively such that the plurality of spacers includes a first spacer positioned between the first end member and the first energy storage device and a second spacer positioned between the second end member and the second energy storage device.

10. The energy storage apparatus according to claim 1, wherein the first energy storage device is formed such that the wall thickness of the opposite side wall portion in the case is in a range of 0.3 mm to 1.0 mm.

11. The energy storage apparatus according to claim 1, wherein the first energy storage device is formed such that a difference between the wall thickness of the one side wall portion and the wall thickness of the opposite side wall portion in the case is in a range of 0.1 mm to 0.7 mm.

12. The energy storage apparatus according to claim 1, wherein the first energy storage device is formed such that the wall thickness of the one side wall portion is 1.1 times or more the wall thickness of the opposite side wall portion in the case.

13. The energy storage apparatus according to claim 1, wherein the second energy storage device is formed such that the case of the second energy storage device has one side wall portion positioned adjacent to the second end member and an opposite side wall portion positioned on an opposite side with respect to the one side wall portion and that a wall thickness of the one wall portion is formed larger than a wall thickness of the opposite side wall portion.

14. The energy storage apparatus according to claim 13, wherein the plurality of energy storage devices is formed such that the energy storage devices have a same width in the first direction.

15. The energy storage apparatus according to claim 13, wherein the plurality of energy storage devices includes at least one energy storage device arrayed between the first and second energy storage devices such that the at least one energy storage device has the case having one side wall portion with a wall thickness that is larger than a wall thickness of an opposite side wall portion and that the case of the first energy storage device, the case of the second energy storage device and the case of the at least one energy storage device have a common structure.

16. The energy storage apparatus according to claim 13, wherein the first and second energy storage devices are formed such that the case of each of the first and second energy storage devices includes a lid body closing an opening of the case and that the lid body is welded onto the one side wall portion with a welding depth that is deeper than a welding depth of the opposite side wall portion.

17. The energy storage apparatus according to claim 13, wherein the case includes a case body and a lid body closing an opening end portion of the case body such that the case body is formed of a single member comprising the one and opposite side wall portions.

18. The energy storage apparatus according to claim 14, wherein the plurality of energy storage devices includes at least one energy storage device arrayed between the first and second energy storage devices such that the at least one energy storage device has the case having one side wall portion with a wall thickness that is larger than a wall thickness of an opposite side wall portion and that the case of the first energy storage device and the case of the at least one energy storage device have a common structure.

19. The energy storage apparatus according to claim 13, wherein the plurality of energy storage devices includes at least one energy storage device arrayed between the first and second energy storage devices such that the at least one energy storage device has the case having one side wall portion with a wall thickness that is larger than a wall thickness of an opposite side wall portion.

20. The energy storage apparatus according to claim 13, wherein the plurality of energy storage devices includes at least one energy storage device arrayed between the first and second energy storage devices such that the case of the at least one energy storage device has one side wall portion and an opposite side wall portion with a same wall thickness.
